(19) United States
(12) Patent Application Publication
(10) Pub. No.: US 2014/0317078 A1
(43) Pub. Date: Oct. 23, 2014

(54) METHOD AND SYSTEM FOR RETRIEVING INFORMATION

(71) Applicant: SkillPages Holdings Limited, Blackrock (IE)

(72) Inventors: Michael Gallagher, Blackrock (IE); Padraic Mulligan, Artane (IE); Dave Daly, Dublin (IE); Iain Mac Donald, Dublin (IE)

(73) Assignee: SkillPages Holdings Limited, Blackrock (IE)

(21) Appl. No.: 14/254,109

(22) Filed: Apr. 16, 2014

Related U.S. Application Data
(60) Provisional application No. 61/813,241, filed on Apr. 18, 2013.

(51) Int. Cl. G06F 17/30

(52) U.S. Cl. CPC G06F 17/30867; G06F 17/30598
USPC 707/706; 707/723

(57) ABSTRACT

The present disclosures relates to a computer implemented method and system for retrieving information. The method comprises inputting data to generate one or more records. Storing the one or more records. Classifying one or more pieces of data in the one or more records so as to associate the pieces of data to one or more concepts. Enriching the one or more records with metadata identifying concepts to which the pieces of data are associated. Inputting a search query to motivate a search of the one or more records. Classifying data of the search query by associating the data of the search query to one or more concepts. Matching the one or more concepts associated with the data of the search query with the one or more concepts associated with the one or more records. Ranking and filtering matching records based on one or more factors. Returning search hits based on the matching step.

### FIELD OF THE INVENTION

The present disclosure relates to a method and system for retrieving information. More particularly, the present disclosure relates to matching and ranking in the context of an online search and using metadata to enrich information retrieval. In addition, the disclosure relates to matching and ranking of individuals or businesses offering skills, goods or services for sale, hire or collaboration.

### BACKGROUND

The internet and other communication networks are used by individuals and businesses to maintain an online presence. The purpose of this presence is manifold. Firstly, it is to give information about their services, skills, products, profession, employment or interests. Secondly, such a presence allows them to conduct sales, communications, logistics and collaborations or contracts of work relating to their business, service or skill within a networked electronic environment of the internet. Thirdly, they have the goal of being discovered by other businesses or individuals who may wish to employ, engage, collaborate, contract or make purchases in relation to their skills, interests, services or goods offered.

The seeking and accessing of such information has been aided by the development of computer programs capable of searching databases which store such information. These searches are performed with the inputs of user data either in the form of user specified queries or the creation and posting of records/documents outlining a service need, job vacancy or desired collaboration. However, much information remains difficult or cumbersome to retrieve.

Many of those searching for individuals and businesses are frustrated by their lack of success in finding suitable matches for their particular need. And when matches are found for their need, these may be so numerous that they result in difficulty identifying the most suitable matches. This may be in part due to poor ranking of suitability of individual matches relative to the need of those seeking the information.

Traditional online search has relied on basic keyword and string matching, leading to the frustrations outlined previously. To create a truly powerful, effective and useful online search utility, it is imperative to move far beyond simplistic mechanical matching of keywords.

There is therefore a need for a system and a method for retrieving information which addresses at least some of the drawbacks of the prior art.

### SUMMARY

Accordingly, the present disclosure relates to a computer implemented method for retrieving information as detailed in claim 1. Furthermore, the present disclosure relates to a computer system for retrieving information as detailed in claim 29. Advantageous embodiments are detailed in the subsidiary claims.

In one aspect there is provided a computer implemented method for retrieving information using a computer system; the method comprising:
inputting of data to generate one or more records;
storing the one or more records;
classifying one or more pieces of data in the one or more records so as to associate the pieces of data to one or more concepts;
enriching the one or more records with metadata identifying concepts to which the pieces of data are associated;
inputting a search query to motivate a search of the one or more records;
classifying data of the search query by associating the data of the search query to one or more concepts,
matching the one or more concepts associated with the data of the search query to the one or more concepts associated with the one or more records;
ranking and filtering matching records based on one or more factors; and
returning search hits based on the matching step which are ordered and filtered by the ranking step.

In another aspect the one or more records comprise one or more fields. Advantageously, the one or more records comprises a plurality of fields of which at least one field includes text data. Preferably, classification of the one or more pieces of data uses a repository of concept data and concept metadata. Ideally, the repository includes nodes that represent concepts. In one example, the nodes have associated metadata.

In a further aspect the metadata comprises identifiers, words and terms in the form of strings, and types and scaled features.

In one exemplary aspect, the repository comprises edges for connecting nodes thereby representing the interrelatedness of the concepts that the nodes represent. Advantageously, an edge has associated metadata that represent the type and strength of the relationship between the concepts represented by the two connected nodes. Ideally, the classification of the one or more pieces of data includes one or more comparison techniques. Preferably, the one or more comparison techniques associate a given piece of text to zero, or one or more concepts with a confidence score.

In one aspect, a set of configuration instructions determines the type, number and order of comparison techniques, as well as the selection of concept data from the repository. Advantageously, concept associations derived from different comparison techniques are combined to produce distinct set of associations along with scores indicating the confidence of those associations. Ideally, the score generated for each association is dependent upon the comparison technique or combination of comparison techniques used to make that association. Preferably, the score for an association depends on the relationship of that concept to other concept associations produced within that classification operation. In one example, the score for an association depends on the relationship of that concept to concepts associated to data previously inputted by a data provider. In one arrangement, the score for an association depends on the relationship of that concept to concept associations of data previously inputted by social connections of a data provider. Ideally, the score for an association depends on the relationship of that concept to concept associations of data previously inputted by other participants that share similar profile attributes to a data provider.

In another aspect the one or more records are stored along with identifiers of concepts to which they have been associated and scores indicating the confidence of those associations. Ideally, the records are stored along with associated geographical location data.

In one aspect wherein matching the search queries includes classifying the search queries using a repository of concept data and concept metadata.

In a further aspect, a search engine is configured to match search queries to stored records based on concepts and geographical location data to which the search queries and stored records have been associated.

In an exemplary aspect, during matching dynamic adjustment of different thresholds are made to achieve a required volume of search hits. Advantageously, the dynamic adjustment includes adjusting geographical location data. Ideally, the dynamic adjustment includes changing the concept type, or the combination of concept types, that constitute a valid match. Preferably, the dynamic adjustment includes using certain similar or related concepts to the associated concepts of the search query to facilitate a match.

In another aspect the metadata of the concept associated to a search query determines thresholds for the dynamic adjustment.

In a further aspect one or more factors, influencing the ranked order and filtering of matching records, comprise at least one of:
a measure of textual similarity of the contents of the record and the search query;
a measure of conceptual similarity of the record and search query;
a measure of geographical proximity of a record provider to searcher who inputs the search query with reference to relativeness of that geographical proximity based on concept associated;
a measure of the likelihood that a search hit will be selected if present within the search hits;
a measure of the quality and volume of peer recognition of a search hit, or the provider of a search hit;
measures of quality, extensiveness and recency of content uploaded by the provider of the search hit;
a measure of volume and quality of content external to system referenced by the provider of the search hit;
a measure of quality and extensiveness of provider's social connections network;
a measure of interconnectivity of provider's social connections relative to the searcher's social connections; and
a measure of level of activity of the provider within the system.

The present disclosure further relates to a computer system for retrieving information; the system comprises:
a data input interface for inputting of data to generate one or more records;
a memory for storing the one or more records;
a classification module for classifying one or more pieces of data in the one or more records so as to associate the pieces of data to one or more concepts;
an enriching module for enriching the one or more records with metadata identifying concepts to which the pieces of data are associated;
a search interface configured to input a search query to motivate a search of the one or more records;
a classification search module configured for classifying data of the search query by associating the data of the search query to one or more concepts,
a matching module configured for matching the one or more concepts associated with the data of the search query with the one or more concepts associated with the one or more records;
a ranking module configured for ranking and filtering matching records based on one or more factors; and
a search engine configured for returning search hits using data from the matching module and the ranking module.

The present disclosure describes an exemplary market matching skills and services relevance engine that helps connect people looking for skills or services to people who provide those skills or services in a more accurate way than was previously possible.

Within an exemplary system, skills and services are modeled as concepts. A concept is represented by collections of strings and terms as well as other metadata thereby giving a rich description of the multitude of ways a concept may be referenced or characterized within diverse human cultures and communities. Furthermore, by modeling these concepts in a graph structure, the interconnectedness and overlapping of concepts is expounded.

The metadata describing the concepts seeds a highly configurable classification subsystem that can map human inputted terms and records onto one or more concepts. By comparing the concept identities associated to user inputs from the seeker and provider sides of the market, matches are enabled that transcend the textual representations inputted.

Finally, a ranking subsystem orders the available matches, not just on the proximity and confidence of concepts associated, but also on a variety of other relevant dimensions and features. These dimensions account for factors that are pertinent when seeking a skill or service provider, such as geographical proximity, credibility, trustworthiness, willingness to engage and quality of information provided.

The foregoing and other features and advantages of preferred embodiments of the present disclosure are more readily apparent from the following detailed description. The detailed description proceeds with reference to the accompanying drawings.

### BRIEF DESCRIPTION OF THE DRAWINGS

The present disclosure will now be described with reference to the accompanying drawings in which:

FIG. 1 is a block diagram illustrating an exemplary system for retrieving information.

FIG. 2 is a block diagram illustrating example components of the system of FIG. 1.

FIG. 3 illustrates an example of configuration instruction sets used to set up a classification module.

FIG. 4 is an input output diagram illustrating an example user input classification operation.

FIG. 5 illustrates a representation of an example of a graphed repository of concept data.

FIG. 6 illustrates an example skill record inputted by a skill or service provider.

FIG. 7 is a flowchart illustrating an example content creation and posting operation.

FIG. 8 is a flowchart illustrating an example of a searching, matching, ranking and filtering operation

FIG. 9 is a block diagram illustrating an exemplary architecture of the system of FIG. 1.

FIG. 10 illustrates a representation of an example of a concept node and string metadata associated to it from different languages.

FIG. 11 illustrates a representation of an example of two concept nodes and string metadata associated to them from different locales of the same language.

FIG. 12 is a flowchart illustrating an example of how an update for a repository of concept data is identified and then incorporated.

FIG. 13 is an input output diagram illustrating an example user input being classified by a suitably configured classification module for an online dating site.

### DETAILED DESCRIPTION

Various embodiments of the present disclosure generally relate to systems and methods that enable the searching of providers and practitioners of skills and services. More specifically, some embodiments of the present disclosure relate to an environment in which those searching for providers and practitioners of skills and services receive suitably ranked results that accurately satisfy their particular needs.

The techniques introduced here can be embodied as special purpose hardware (e.g. circuitry), or as programmable circuitry appropriately programmed with software and/or firmware, or as a combination of special-purpose and programmable circuitry. Hence various embodiments may include a machine-readable medium having stored thereon instructions which may be used to program a computer (or other electronic devices) to perform a process. The machine readable medium may include, but is not limited to, optical disks, compact disk read-only memories (CD-ROMs), and magneto-optical disk, ROMs, erasable programmable read-only memories (EPROMs), electrically erasable programmable read-only memories (EEPROMs), magnetic or optical cards, flash memory, Solid State Drives (SSDs) or other type of media/machine-readable medium suitable for storing electronic instructions.

Various embodiments and implementations of a skills and services matching and relevance engine will now be described. The following description provides specific details for a thorough understanding and enabling description of these implementations. One skilled in the art will understand, however, that the disclosure can be practiced without many of these details. Furthermore, while the current embodiment is described in terms of providers and seekers of skills and services, the intention is not to limit the disclosure to the particular embodiment described. On the contrary, the disclosure is intended to cover any concepts that are textually described, stored electronically either in closed machines or in networked environments, such as the internet, that are intended to be searched, matched and ranked using an equivalent infrastructure of the disclosure defined. Additionally, some well-known structures or functions may not be shown in detail, so as to avoid unnecessarily obscuring the relevant descriptions of the various implementations. The terminology used in the description presented below is intended to be interpreted in the broadest possible manner, even though it is being used in conjunction with a detailed description of certain specific implementations of the disclosure.

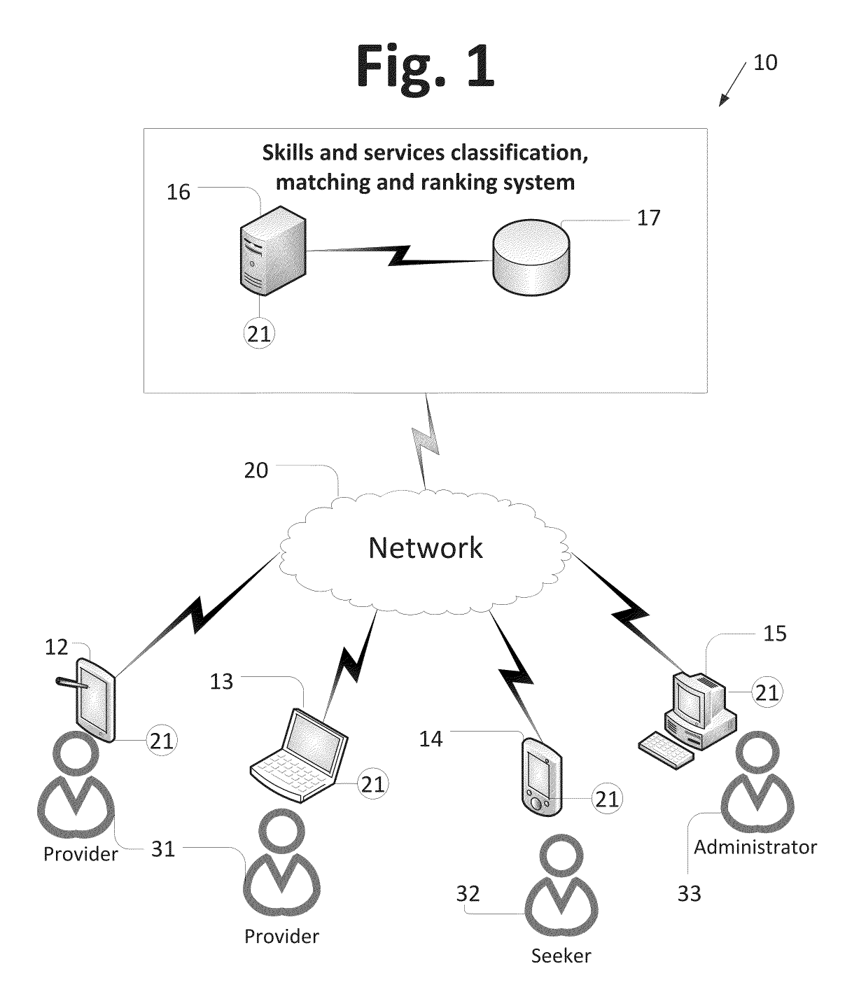

FIG. 1 is a block diagram illustrating an exemplary system 10 for retrieving information. In the exemplary embodiment the system 10 is configured to operate as a skills and services classification, matching and ranking system. Participants in the system 10 include one or more providers of skills, services or goods 31, one or more seekers of skills, services or goods 32. The system 10 may also have one or more administrators 33. Examples of seeker participants 32 include, but are not limited to, potential employers, contractors, customers, clients, partners or collaborators 32. The participants interact with the system 10 across networks 20 using one or more client devices 12, 13, 14, 15 (four of which are illustrated by way of example). The client devices 12, 13, 14, 15 include but are not limited to desktop computers, laptop computers, personal digital/data assistants (PDAs), mobile phones, smart phones, tablet computers, non-mobile phones, interactive TV systems through set top boxes for cable television (CATV), satellite television or other television networks, Internet appliances and other types of network devices.

The system 10 may provide various graphical user interfaces. The participants 31, 32, of the system 10 may access these graphical user interfaces and other facilities of system 10 using web or mobile browsers, such as Google Chrome, Internet Explorer and Opera, or client applications (mobile or desktop applications) and the like installed on their client devices 12, 13, 14, 15.

The client devices 12, 13, 14, 15 communicate with one or more information servers network device 16 (one of which is illustrated by way of example) using one or more wired or wireless communications protocols over a communications network 20. The one or more information server network devices 16 include one or more server hosting a website or other hosted service for example a secure API for communicating with client applications. The one or more information server network devices may also include file servers or other types of servers.

The communications network 20 includes, but is not limited to, the Internet, an intranet, a wired Local Area Network (LAN), a Personal Area Network (PAN), a Wireless Local Area Network (WiLAN), a Wide Area Network (WAN), a Metropolitan Area Network (MAN), Public Switched Telephone Network (PSTN), Internet Area Network (IAN) and other types of communications networks 20 providing voice, video and data communications.

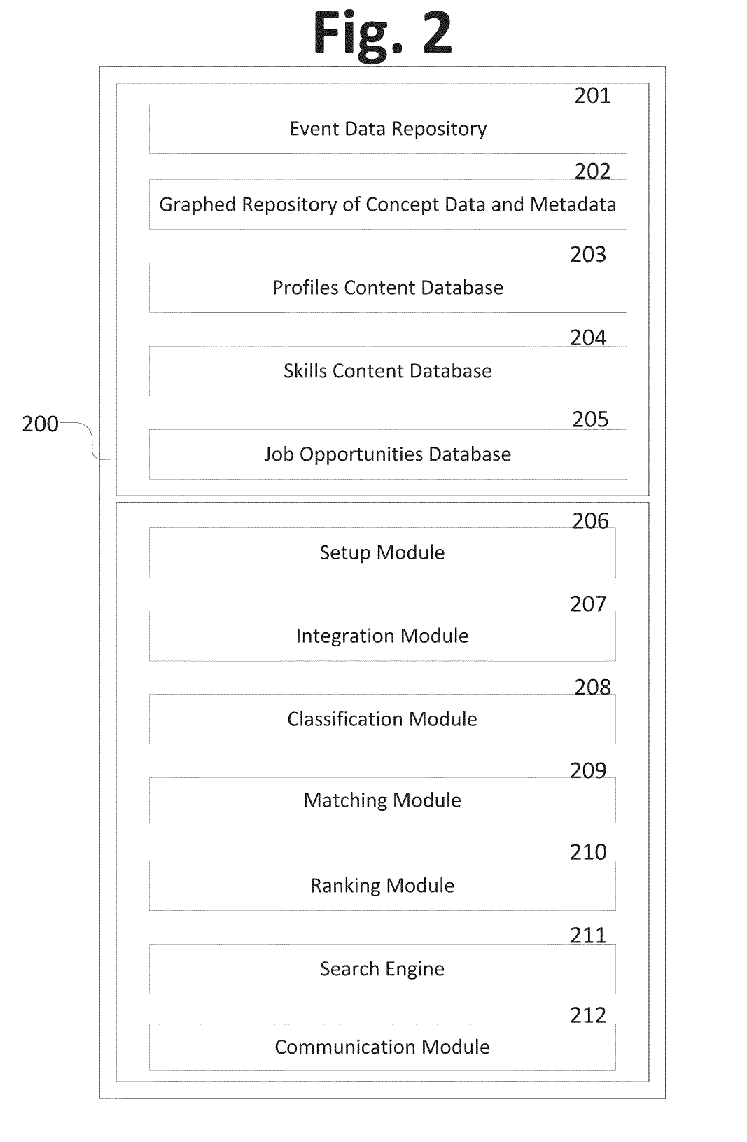

FIG. 2 is a block diagram illustrating example components of the system 10. In one embodiment, the system 10 comprises various database components, including but not limited to, an event data repository 201, a graphed repository of concept data and metadata 202, a profiles database 203 containing information provided by both seeker participants 32 and provider participants 31, a skills database 204 containing processed information provided by provider participants and job opportunities database 205 containing processed information provided by seeker participants.

In one embodiment, the system 10 also comprises various modules including a setup module 206, an integration module 207, a classification module 208, a matching module 209, a ranking module 210, a search engine 211 and a communication module 212. The setup module 206 manages the viewing and updating of the database. The integration module 207 handles the integration of external applications. The classification module 208 handles the association of user inputted queries and data to concepts modeled in the graphed repository of concept data 202. The matching module 209 handles the management of the search engine 211 to deliver collections of matching content data. The ranking module 210 performs filtering and ranking operations on matched content data. The communication module 212 manages communication among the participants.

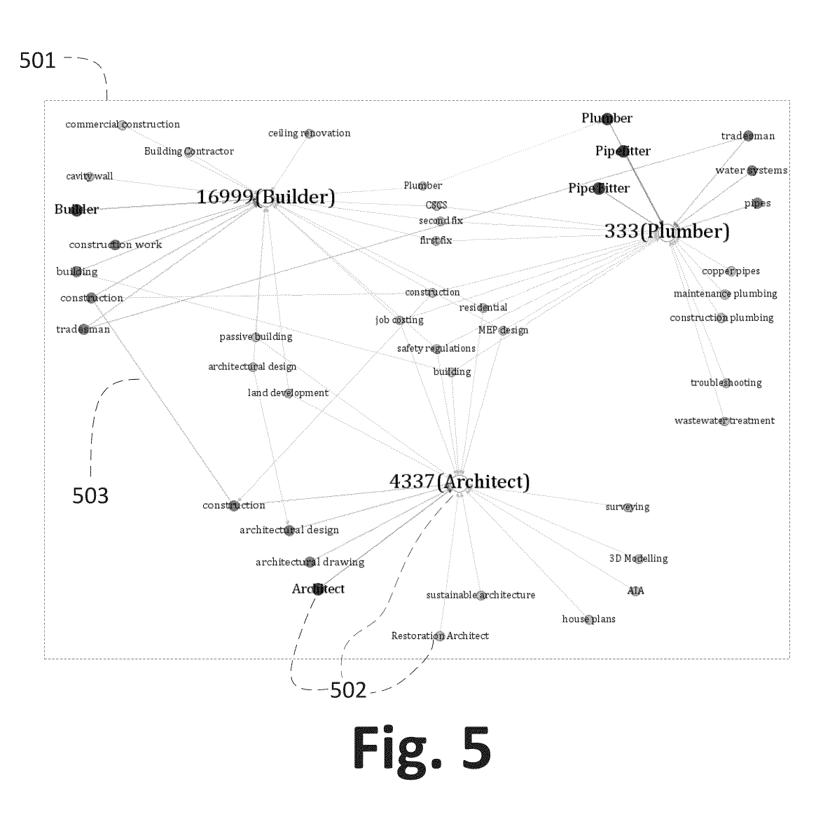

FIG. 5 illustrates a graphical representation 501 which provides a visually preceptible representation of the contents of a graphed repository of concept data 202. In one embodiment, the data is stored using a database suitable or suitably structured to store graph data, for example Neo4j or NoSQL.

The data is structured as a collection of nodes 502 which represent concepts. Each node has associated metadata which enrich the concept. In one embodiment, metadata includes the type of the concept. The types of concept include but are not limited to profession, hobby, task, specialty and educational course or qualification. Other metadata associated to a node include, but is not limited to, an identifier, string data, a language or locale, a geographical sensitivity score and category membership(s).

The relationships between the nodes are represented by a collection of edges 503, which also may be known, to those skilled in the art, as triples. The edges 503 have metadata associated to them which describe the type of relationship between the two nodes 502 connected by the edge 503.

Using the structure 501 illustrated, a collection of concepts of differing types can be outlined along with features that describe them and the language that represents them. Furthermore the ways in which these concepts are related is modeled thus reflecting interrelationships and overlapping of concepts that occur in the real world.

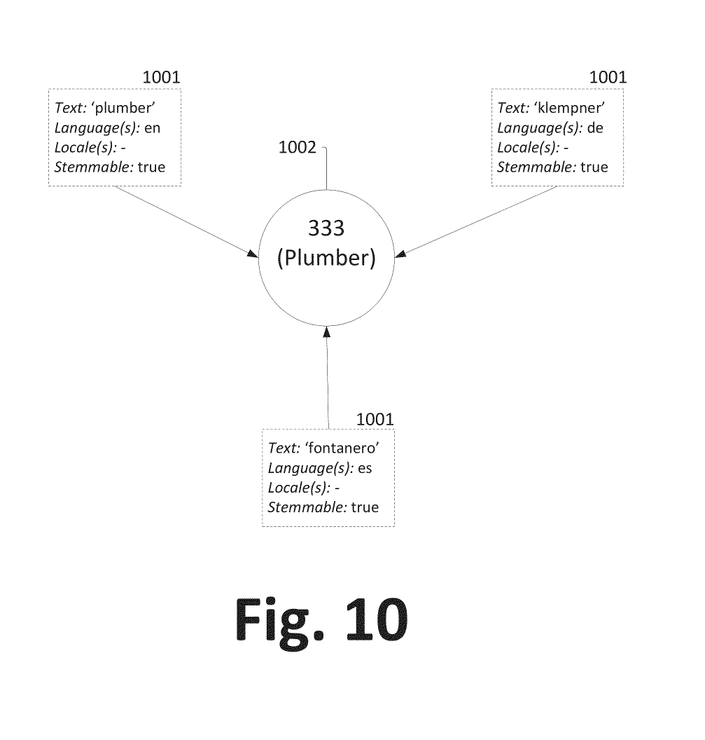

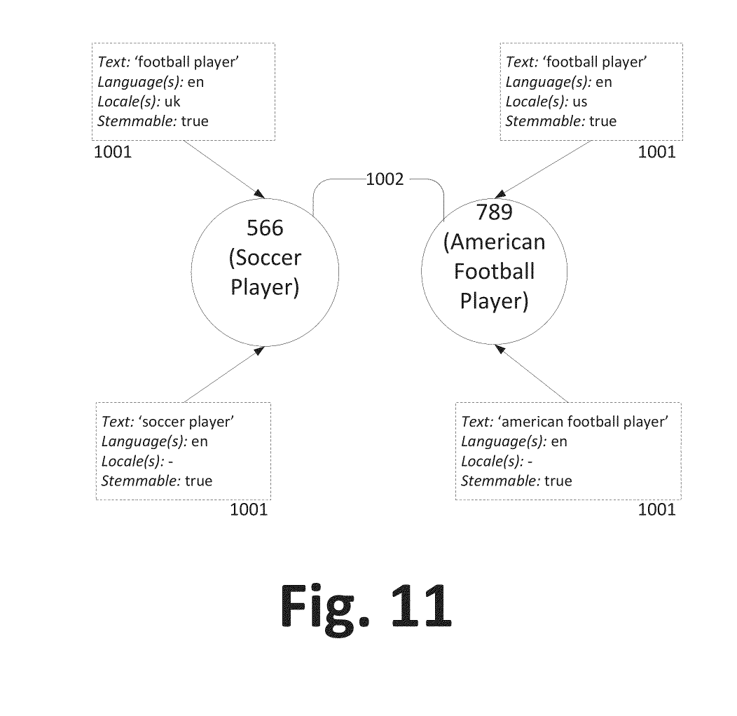

FIG. 10 illustrates a representation of an example of a concept node 1002 and string metadata 1001 associated to it from different languages. FIG. 11 illustrates a representation of an example of two concept nodes 1002 and string metadata associated to them from different locales of the same language 1001. The string data 1001 that is associated to a concept node 1002 take the form of words or terms stored in string format along with their own descriptive metadata. Metadata associated to a word or term can include, but is not limited to, the language(s) of the word or term, the locale(s) (cultures) of the word or term, and items indicating how the text can be manipulated by the classification module 208.

In one embodiment, an example of such an item is a flag indicating whether or not the text can be stemmed when comparing against other strings. Stemming, as those skilled in the art are aware, is a well-known information retrieval technique by which words are truncated to find matches. However for some words or terms this can lead to incorrect matches and as such this process can be omitted where needed as indicated by a stemmable flag contained in the string metadata 1001.

Using the model outlined, a concept node 1002 is only loosely coupled to the string data 1001 that represents it. The different ways that a concept can be textually referenced within a culture or language, in different cultures and even in different languages can all be described and associated to the common concept they represent. By modeling the language(s) and locale(s) to which a specific term belongs, this can be then used to infer which data items to select when processing the inputs of a given participant 31, 32. The language, culture or locale of a participant 31, 32 can be explicitly entered or may be derived from the geographical location of the user, which in turn may be derived using geolocation techniques based on a participant's IP address.

FIG. 10 illustrates how one participant using Spanish can reference ‘Fontanero’, a second participant using English can reference ‘Plumber’, and a third participant using German can reference ‘Klempner’. While distinct pieces of text have been used to reference the same concept, using the model described, the system recognizes that users from across linguistic boundaries are in fact referring to the same single concept, namely, a plumber. Data modeled in this way is extremely beneficial to say a Mexican immigrant residing in the US. This immigrant may have content uploaded to the system 10 in Spanish, which is made searchable for Anglophone users querying in English. They might describe their skill as ‘Fontanero’ and be matched to seeker participants 32 entering the English query ‘Plumber’.

FIG. 11 illustrates how participants 31, 32 using the same term within the same language but in different locales can refer to different concepts. The system recognizes when a participant references ‘Football Player’, they can mean different concepts depending on their culture. If a participant, who is associated to the US locale of English, enters the term ‘Football Player’, the system infers that this user is referring to the concept of American football player. However, if a participant, who is associated to the UK locale of English, enters the term ‘Football Player’, the system infers that this user is referring to the concept of soccer player. Using the model outlined, subtle cultural differences are recognized by the system 10 using a combination of the locale metadata attached to the strings referenced in the concept repository, and language and geographical location information associated to a participant 31, 32.

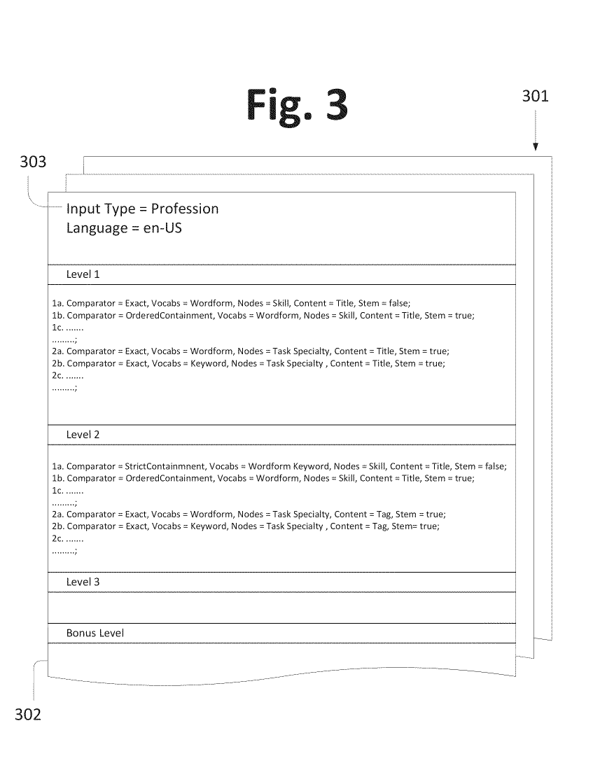

FIG. 3 illustrates an example set (of sets) of configuration instructions 301. In one embodiment, on start-up, the classification module reads in sets of configuration instructions 301. Each set of configuration instructions 302 determines how an input with a particular set of types 303 will be processed during classification. Using these instructions the classification module accesses required data from the repository of concept data 202 and uses this to build multiple in-memory comparators 421 as per those described within the configuration instructions 301.

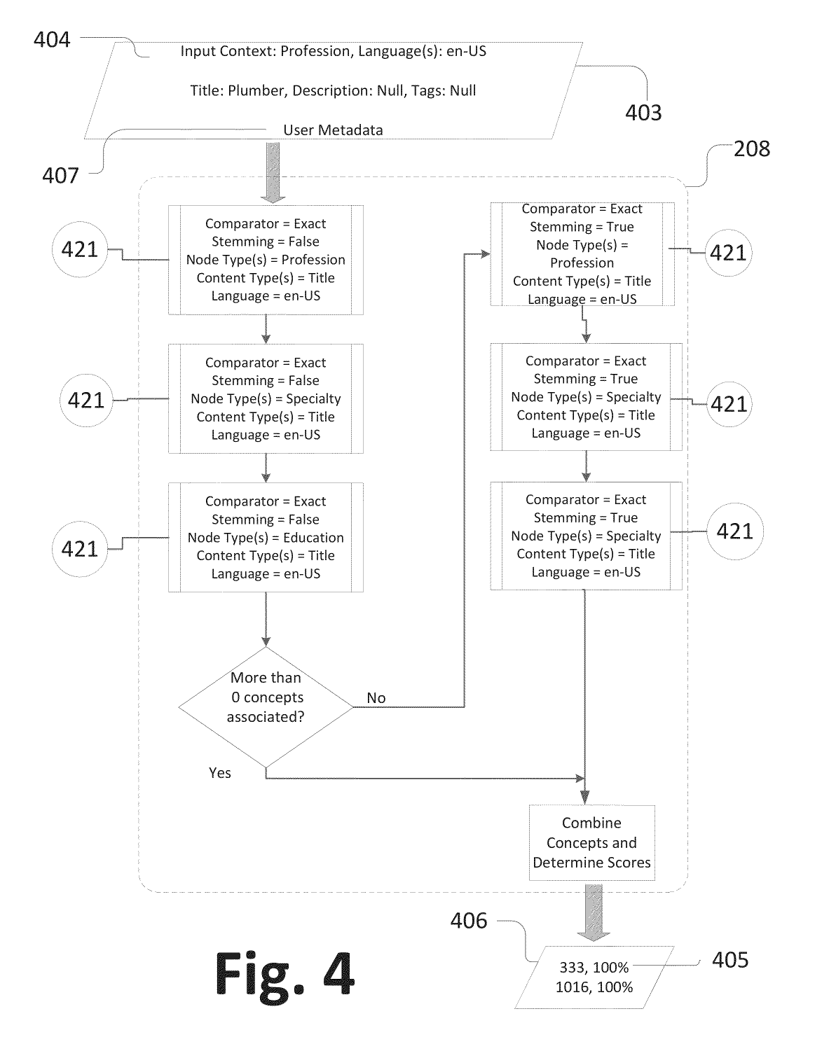

FIG. 4 illustrates an example of how an input 403 is processed by a configured classification module. Following configuration, the classification module 108 can process a variety of inputs 403. In one embodiment, the inputs that can be processed include but are not limited to profession titles and descriptions, job titles and descriptions, skill titles and descriptions, specialties, education courses, search queries, résumé segments, hobbies and interests. Provided with each input 403 is a group of types 404 that describe the input. In one embodiment, the types 404 describe the context in which this data was inputted and the language or languages of the participant. Also provided is a set of user metadata 407 relating to the participant who created the input.

Each combination of types 404 has a set of comparators 421 to be used and an order in which they are to be accessed, predetermined by a set of configuration instructions 302. Each comparator 421 has the potential to associate the input 403 to zero one or more concept identities 406 from the semantic concept graph 202. Once an input has been processed by the necessary comparators 421, all associated concepts generated by the comparators 421 are combined. A distinct set of zero, one or more associated concept identities 406 remains along with a confidence score 405 for each. The confidence score 405 for an associated concept identity 406 is determined by a number of factors. In one embodiment, these factors include the comparator 421 or combination of comparators 421 used to generate an association, the graphed relationship to other concept identities associated during that classification operation, as well as the graphed relationship to concepts identities already associated to the profile or social network (accessed via user metadata 407) of the participant that created the input. Information on the relationships between concepts identities is accessed from the graphed repository of concept data 202.

In one embodiment, the profiles content database 203, the skills content database 204, and the job opportunities database 205 contain participant inputted data items which have passed through the classification module. The user created records are persisted along with enriching information regarding the records' associated concept identities and confidence scores.

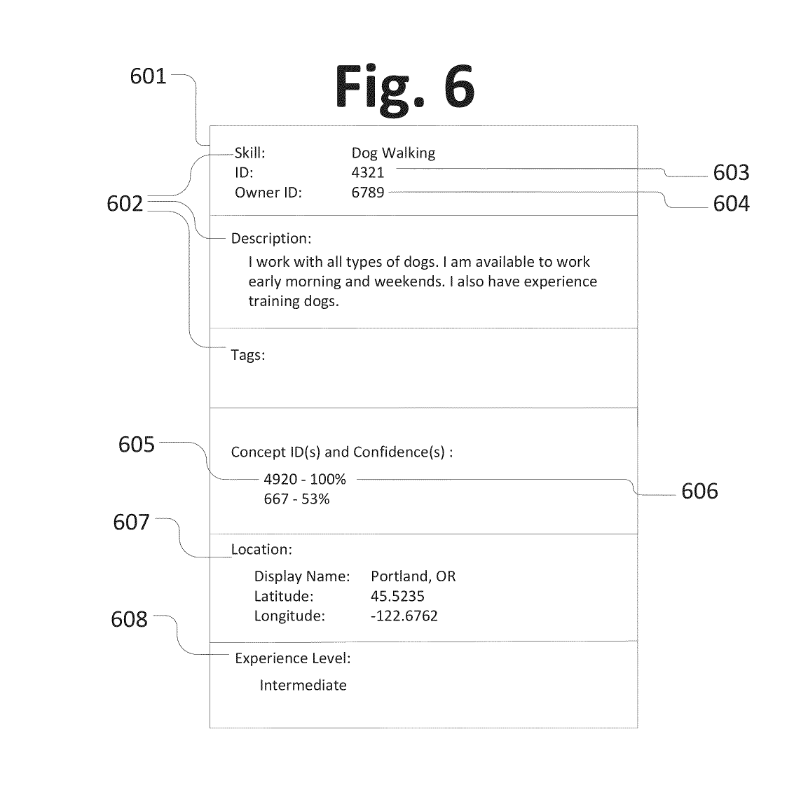

FIG. 6 illustrates an example of a data record created by a provider participant 31. In one embodiment, this is a skill or service record 601. The skill or service record 601 contains basic pieces of input text 602 which describe the skill or service. It contains an ID 603 that identifies the skill or service record, and an ID 604 that identifies the participant profile who owns the skill or service record 601. It contains zero, one or more concept identifiers 605 that have been associated to the skill along with the confidence of those associations 606. The skill or service record 601 also contains information regarding the geographical location 607 of the participant offering the skill or service. In one embodiment, it also contains information regarding the level of experience 608 of the participant offering the skill or service.

As discussed above, in one embodiment, a user input and user metadata 403 are passed into the classification module 208 which then outputs a set of concept IDs 406 and confidence scores 405. The concept identifiers 406, confidence scores 405, concept metadata, the user input text and geographical location are passed to the matching module 209. The matching module 109 leverages the search engine 211, to perform one or more searches in order to find a volume of potential matching items 601 from the content databases 203, 204, 205 appropriate to the seeker participant's 32 need and context.

The matching module 209 can dynamically adjust a number of different thresholds when matching with the purpose of fulfilling the volume of results required. Such threshold adjustments include, but are not limited to, expanding the location area of the search, changing the confidence score threshold of the input and/or the stored records, narrowing or expanding the types (or combinations thereof) of associated concept identities accepted, expanding the number of potentially matching concept identities by querying the graphed repository 202 for similar or related concept identities.

In one embodiment, the expansion adjustments are guided by the metadata of the concept identity(ies) already matched. In one example, the matching module 209 may use the metadata feature of geographical sensitivity score as a guide. A seeker participant 32 is searching for a “graphic designer”. The geographical sensitivity score of the concept identity associated to the “graphic designer” query is low, and so if a first search in the search engine 211 returns an insufficient volume of results, the matching module 209 will expand the geographical area from say neighborhood to city level. In another example, a seeker participant 32 is searching for a “dog walker”. The geographical sensitivity score of the concept identity associated to the “dog walker” query is high, and so if a first search in the search engine 211 returns an insufficient volume of results, the matching module 209 will not expand geographical area. Instead, the matching module may query for similar concepts. The graphed repository 202 models concept identities representing concepts such as pet sitter, dog trainer, or animal lover as being sufficiently related to the concept identity associated to “dog walker”. Thus the matching module can expand its search to also match skill or service items associated to these additional concept identities.

The primary goal of the matching and matching expansion processes is to match a set of potential data items that are both highly suitable and give enough results to enable extended discrimination on multiple heterogeneous criteria by the seeker participant 32.

As discussed above, the classification module 208 and matching module 209 generate a set of matching data items based on a query input by a seeker participant 32. These matching data items are passed to the ranking module 210 along with the associated concept identities and confidence scores, the query input, geographical location, metadata for each data item and metadata relating to the seeker 32.The ranking module 210 uses this information to evaluate the data items along a number of different dimensions.

Each data item is given a text matching score (TMS). This score is generated using common text retrieval techniques. In one embodiment, such techniques include, but are not limited to Boolean retrieval, compound term processing, cosine similarity and Tf-Idf (Term Frequency-Inverse Document Frequency). TMS increases the ranking of items containing text most closely matching the search criteria.

Each data item is given a concept mapping score (CMS). CMS is calculated by comparing the concept identity and confidence score set associated to the query input against the analogous set for each matching data item. The more concept identities that a data item has in common with the query and the higher the relevant confidences, the higher the item will be ranked.

Each data item is given a geo proximity score. Geo proximity is a measure of distance between the seeker participant 32 and provider participant 31. In one embodiment, geo proximity is not taken as a pure distance factor. Certain geo bounds are also factored in, for example, if the skill provider is close to suitable public transport. The weighting of the importance of the geo proximity score in overall ranking is dependent on geographical sensitivity metadata of the associated concept identities.

Included in the metadata for a data item is a score for search click through rate (CTR). The CTR score is derived from the likelihood of a seeker participant 32 to click on a skill provider in a set of search results. Calculation of the CTR score is made by analyzing historic events recorded in the events repository 201. The algorithm calculating the CTR score takes into account both clicks and the position of an item in a set of results when those clicks were made. Those items with a high CTR score are ranked higher.

Included in the metadata for a data item is a contact provider request (CPR) score. The CPR score is derived from the likelihood of a seeker participant 32 to initiate communication with a provider participant. Communication initiation can occur through a number of supporting services provided by the communication module 212, these include but are not limited to messaging, instant messaging, live chat, SMS, phone or email. The algorithm calculating the CPR score accounts strongly for CPR attempts which are unique to a participant. Those items with a high CPR score are ranked higher. Events relating to communication within the system are recorded in the events repository 201.

Also related to communication events and included in the metadata for a data item is a provider response level (PRL) score. The PRL score is derived from the response times of a provider participant 31 to communications they receive from seeker participants 32. Engagement is a critical factor for seeker participant 32, by communicating expected response service level agreements (SLAs) to provider participants 31 and monitoring response times, providers who continually demonstrate quick response times are rewarded with higher ranking

Peer endorsement is another dimension considered by the ranking module 210. Peer endorsement is an important factor in determining skill or service provider quality. In one embodiment, the peer endorsement dimension factor is calculated by taking the set of endorsements for a provider participant and applying an aging algorithm. The aging algorithm thus ensures providers who are actively receiving peer endorsements are ranked higher than those who are not. Data relating to peer endorsements is stored and accessed in the profiles content database 203.

Some other factors determined by data sourced from the profiles content database are the provider participant's 31 digital footprint strength (DFS), social network strength (SNS), profile content completeness (PCC) score, profile freshness score (PFS) and profile activity score (PAS).

Digital footprint strength (DFS) is an indicator of the credibility and quality of a provider 31. In one example, the DFS increases if the participant's profile is linked to an external website containing information relevant to the skill or service they provide.

Social network strength (SNS) is an indirect means of assessing provider 31 credibility. Participants 31, 32 have the ability to not only create connections within the system, but also to import external social network connections in the form of email addresses or from third party networking sites such as Facebook or Google+. The volume and interconnectedness of a provider's 31 connections as well as their interconnectedness relative to the seeker's 32 connections are factors that are considered when calculating rank. Closer proximity to the seeker 32 as well as density and quality of a provider's 31 network increases ranking

Profile content completeness (PCC) is a measure of content items participants can add to their profile to improve their professional credibility and profile quality. Examples of some content taken into account include, but are not limited to, education history, employment history, and information and various media uploaded relating to projects completed.

Profile freshness score (PFS) is a measure of how recently content items on a profile were created or updated. This means provider participants 31 with content items that were more recently created or updated are ranked higher.

Any events carried out by a participant 31, 32 within the system, for example a login or a status update, are recorded in the events repository 201.Using this data, profile activity score (PAS) is calculated and serves as a measure of how active a participant is within the system. Those participants who are more active are ranked higher.

Finally, each of the individual component dimensions and scores are weighted, combined, and can be adjusted using smoothing and scaling techniques, to produce a ranking score. The matching data items are sorted based on the ranking score. Items can also be filtered based on any individual component or combination thereof.

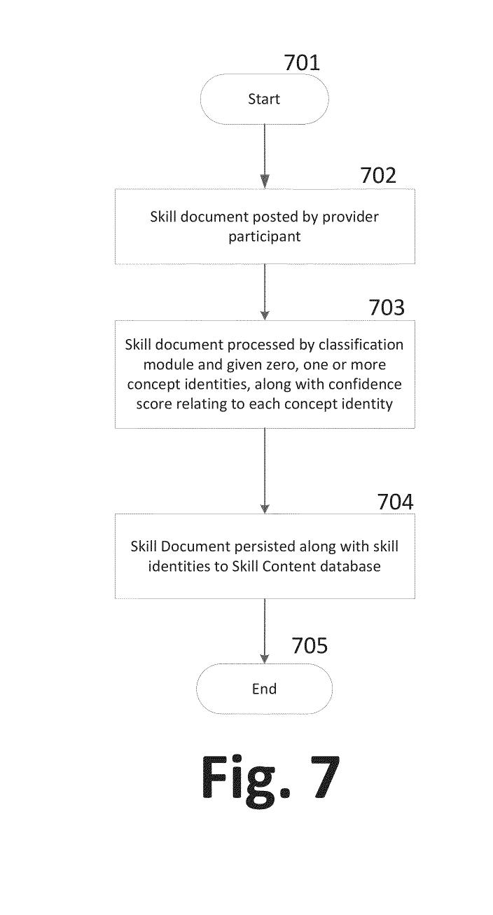

FIG. 7 is a flowchart illustrating an example content creation and posting operation using the skills and services classification, matching and ranking system 10. This operation is achieved through the use of various modules of the system 10 already described. In 702, the provider participant 31 creates and posts a record containing information about a skill or service they provide. This is done through a graphical user interface on a client device 12, 13, 14, 15.

In 703, the integration module 207 passes the record posted by the user along with relevant metadata to the classification module 208, which then returns a set of associated concept identities and confidence scores thus enriching the record by mapping it to concepts modeled in the graphed repository of concept data 202.

In 704, the record 601 is persisted to the skills content database 204 along with the enriching concept identity data 605, 606. In this way, the record 601 is now available to the search engine 211 to index, and in turn available to the matching module 209 as a potential record to be matched during matching operations.

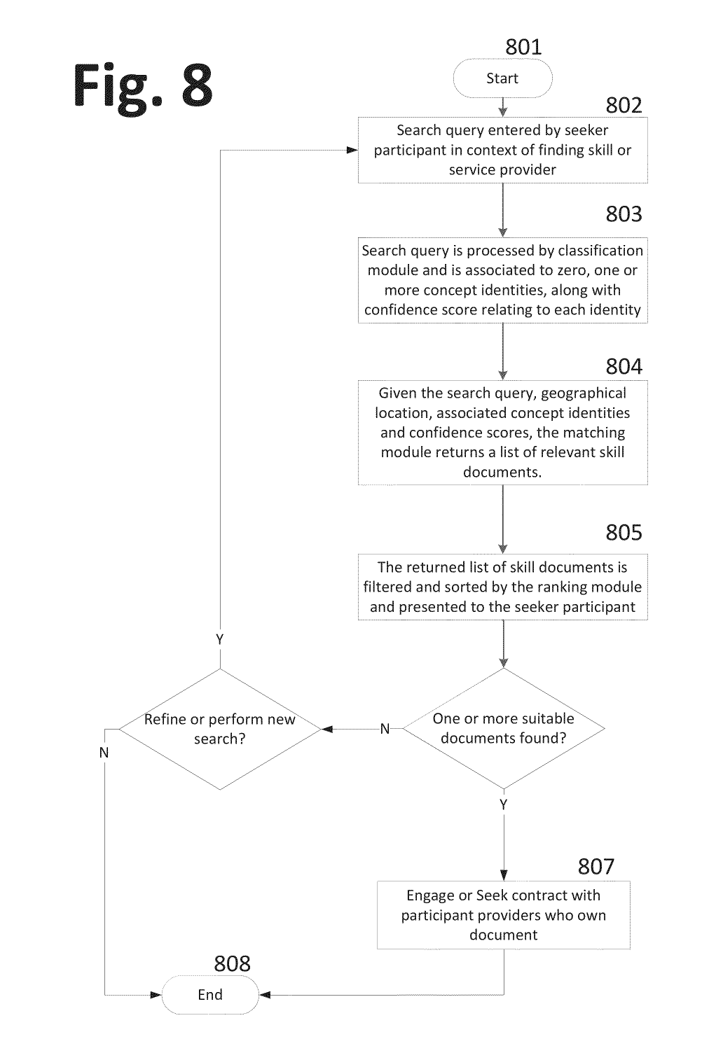

FIG. 8 is a flowchart illustrating an example of a searching operation using the skills and services classification, matching and ranking system 10. This operation is achieved through the use of various modules of the system 10 already described. In 802, the seeker participant 32 inputs a search query relating to a skill or service they are looking for. This is done through a graphical user interface on a client device 12, 13, 14, 15. The geographical location relating to the query may or may not be explicitly described by the seeker participant 32.

In 803, the integration module 207 passes the search query posted along with relevant metadata to the classification module 208, which then returns a set of associated concept identities and confidence scores thus enriching the query by mapping it to concepts modeled in the graphed repository of concept data 202.

In 804, the integration module passes the search query, along with the set of associated concept identities and confidence scores, as well as the geographical location (either explicit, or else derived from participant profile or client device) to the matching module 209. The matching module 209 then returns a list of relevant skill records 601.

In 805, the list of relevant skill records 601 is filtered and sorted by the ranking module 210. The integration module 207, then passes these results back to the client device 12,13,14,15 where they are presented for browsing by the seeker participant 32, through the use of a graphical user interface.

In 807, using these results, the seeker participant 32, if they so desire, can select and engage or seek to contract a provider participant 31 who created the relevant skill or service record(s) 601. If the seeker participant 32 is not happy with the results presented, they can refine their existing search or perform a new search.

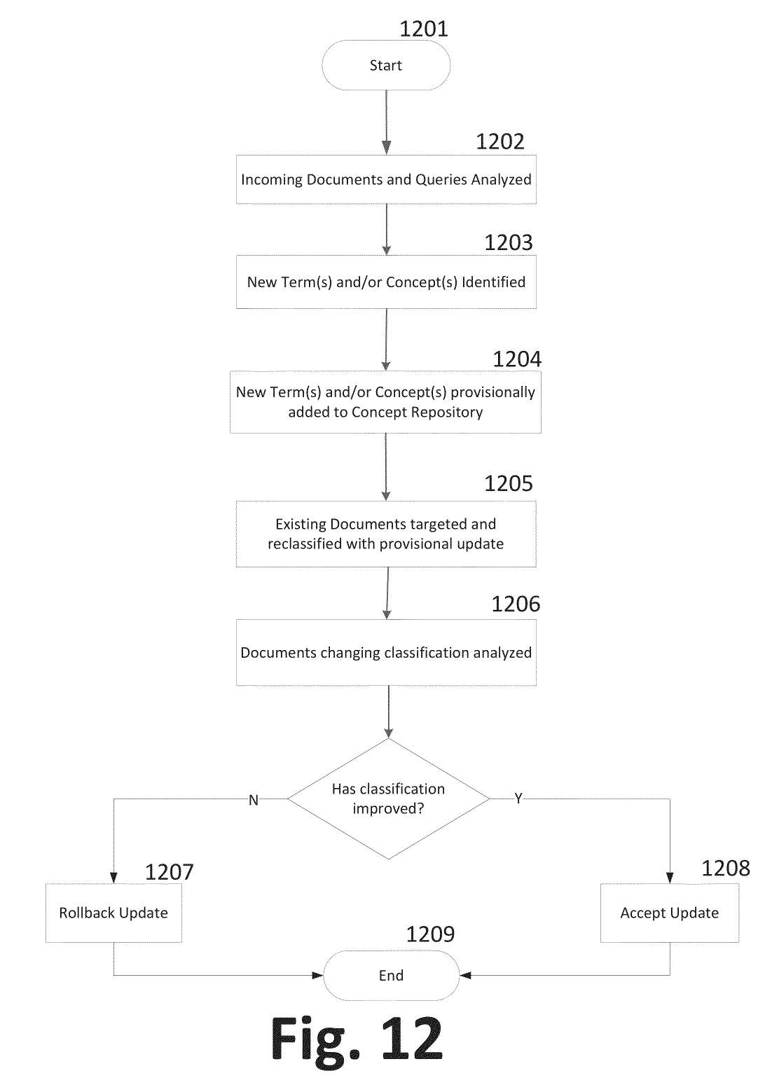

In one embodiment, the data stored in the repository of concept data 202 is not static and is subject to continuous updates. Such updates have the potential to affect the outcome of classification operations including classifications that have already taken place. FIG. 12 is a flowchart illustrating one example of how an update for a repository of concept data 202 is identified, analyzed and then incorporated into the repository.

In 1202, existing records and queries coming into the system are analyzed. In one example, frequently occurring words or terms that are not being associated to any concepts, or which are being associated to concepts only with low confidence scores, are considered for analysis. From this, in 1203, new term(s) and/or concept(s) not present in the repository are identified and presented to an administrator 33.

In 1204, these new term(s) and/or concept(s) are added to the repository creating a provisional version of the repository. Then in 1205, records stored in the system are targeted based on existing associated concepts, confidence scores and full text indexes. These records are reclassified by the classification module 208, which uses the provisional version of the concept data to build new comparators 421. During reclassification, targeted records are assigned a set of associated concept identities and confidence scores.

In 1206, those records that are assigned a set of concept identities and confidence scores that vary from those stored within the system for the same record are presented for further analysis to an administrator 33. For any update that has instigated change in the classification of records, the differing concepts and confidence scores are analyzed. It is decided if the update has caused classification to improve or not. Where it has caused improvement, the update is accepted 1208 and incorporated into the repository. Where it has not caused improvement or has caused disimprovement, the update is rejected and is rolled back 1207.

Hitherto, the current disclosure has been described in terms of providers and seekers of skills and services. However, the intention is not to limit the disclosure to this application, the scope of the disclosure covers any comparable networked environment in which providers and seekers input text or records in relation to what they provide or seek. The data inputted by providers and seekers forms the basis of how they are matched and ranked. The matching and ranking is performed by classifying and associating the data inputted against a repository of concept data.

In a different embodiment, the disclosure could be configured to classify data inputted to an online dating site. Participants in a dating site both create content within the site and also have content from third party sites that relate to their profiles. Any individual section of text within a profile, or section of text about or relating to a profile, can be classified against a suitable repository of concept data with the support of non-textual metadata also relating to their profile. The concepts associated to profiles can then be used as a dimension in matching profiles. In such an embodiment, examples of concepts that could be modeled and classified include, but are not limited to, hobbies and interests, emotional experiences, musical, literary, cultural and artistic tastes, attitudes to religion and spirituality, educational and professional backgrounds, social habits and future goals.

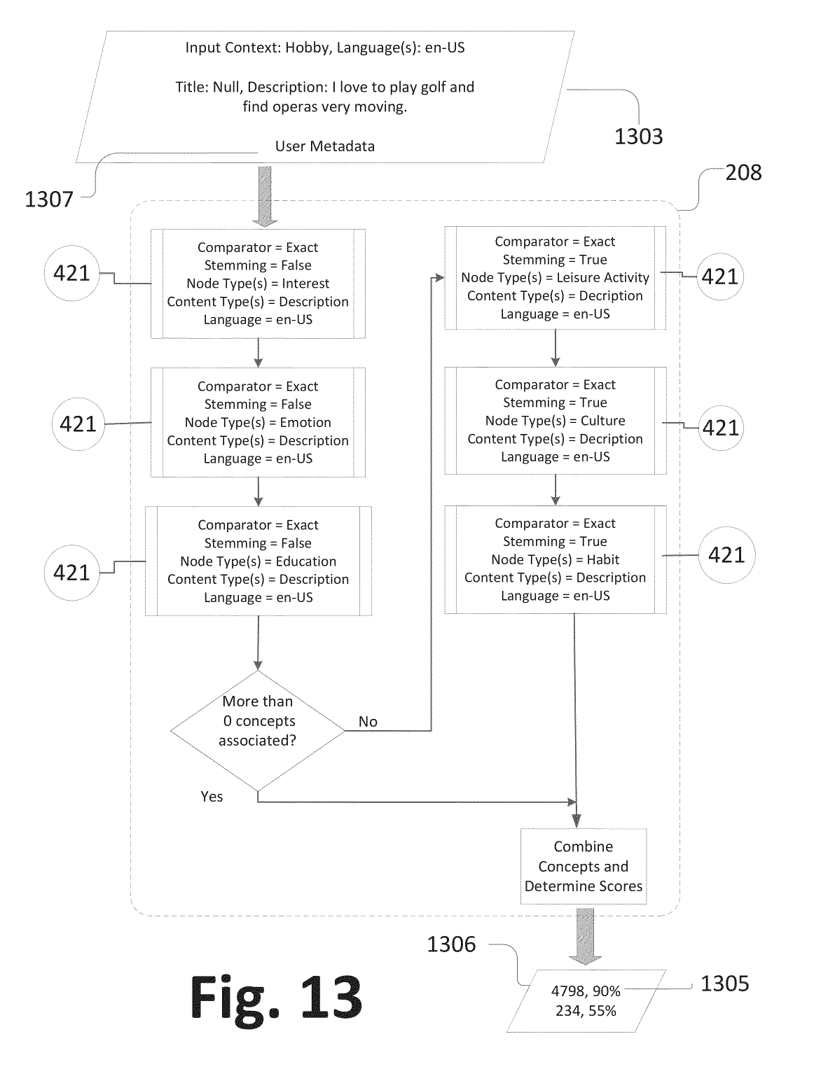

FIG. 13 is an input output diagram illustrating an example user input being classified by a suitably configured classification module for an online dating site. When we compare this figure to the diagram presented in FIG. 4, it can be seen that the module configured for the classification of data input on a skills and services site works in much the same way as one which is configured for classifying data input on a dating site. The major difference is one of configuration in which names representing types vary to aid human understanding. Input contexts in 1303 and 403 vary in name. Corresponding node type(s) accessed from inside the repository of concept data, in order to construct the comparators 421, also vary in name. As can be seen, these variations are simply one of labeling and not a variation in the method of the disclosure itself

Many products, and particularly products bought and sold on the Internet, frequently have multiple sources of textual and other types of data both directly and indirectly associated to them. In another embodiment, the disclosure can be used to classify products that are bought and sold against a suitable repository of concept data. Examples of data sources relating to products include, but are not limited to, product names and alternative names, product types, product descriptions, product reviews, advertising and marketing literature, attribute descriptions, price data and product application descriptions. Once concepts have been associated to products, these concepts can be used to aid the searching, matching and ranking of products within a catalogue.

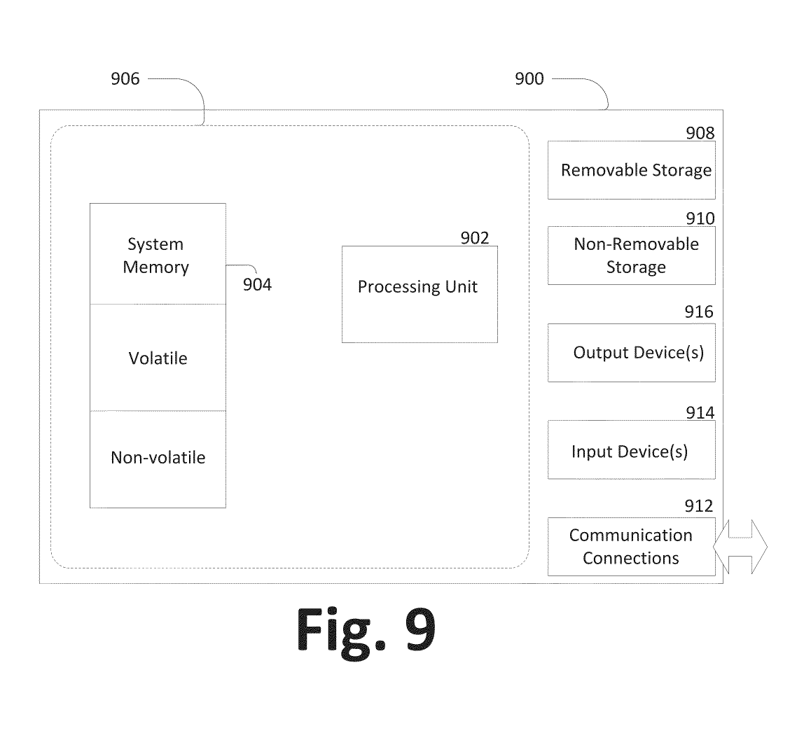

Aspects and implementations of the ranking system 10 of the disclosure have been described in the general context of computer executable instructions, such as routines executed by a general purpose computer, a personal computer, a server and/or other computing systems like commodity based cloud infrastructure 21. FIG. 9 is a block diagram illustrating an example computing device representing the computer systemization of the skills and services classification, matching and ranking system 10 as a skills and services classification, matching and ranking system controller 900. In its most basic configuration, the controller 900 includes one or more processing units 902 and memory 904. Memory 904 may be volatile (ie. RAM), non-volatile (such as ROM, flash memory, etc.) or a combination of both. This most basic system is illustrated in FIG. 9 by dashed line 906. Additionally, controller 900 may also have additional features and/or functionality. For example, controller 900 may also include additional storage (e.g. removable and/or non-removable) including, but not limited to, solid-state drive or magnetic or optical disks or tape. Such additional storage is illustrated by removable storage 908 and non-removable storage 910. Computer storage media includes volatile and non-volatile, removable and non-removable media implemented in any method or technology for storage of information such as computer readable instructions, program modules, data structures, or other data. Memory 904, removable storage 908, and non-removable storage 910, are all examples of computer storage media. Computer storage media includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by controller 900. Any such computer storage media may be part of controller 900. Computer storage media can also include interrelated clusters in a cloud computing architecture such as Amazon Web Services (AWS),

Controller 900 may also contain communication connection(s) 912 that allow the controller 900 to communicate with, and be accessible to, remote devices. Communication connection(s) 912 is an example of communication media. Communication media typically embodies computer readable instructions, program modules, data structures or other data in modulated data signal such as carrier wave or other transport mechanism and include any information delivery media. The term ‘modulated data signal’ means a signal that has one or more of its characteristics set or changed in such a manner as to encode information in the signal. By way of example, and not limitation, communication media includes wired media such as wired network or direct-wired connection, and wireless media such as acoustic, radio frequency, infrared and other wireless media.

Controller 900 may also have input device(s) 914 such as keyboard, mouse, pen, touch input device, voice input device, video input devices, and/or any other input device. Output device(s) 916 such as display or projector, speakers and/or any other output device can also be included.

controller 900 could be implemented in distributed computing environments, where tasks or modules are performed by remotely connected processing devices, linked by a communications network such as a Local Area Network (LAN), Wide Area Network (WAN), the Internet or other similar networks. In a distributed system, program modules or data stores may be located in local or remote memory devices or a combination of both. Distributed computing may be employed to load balance and/or parallelize/aggregate multiple resources available for processing. Alternatively, aspects of the controller 900 may be distributed electronically over networks, thus existing simultaneously in multiple locations. As is apparent to those skilled in the art, different parts of the skills and services classification, matching and ranking system 10 may reside on a server computer, while corresponding parts reside on a client computer.

It will be understood that what has been described herein is an exemplary system for retrieving information. While the present teaching has been described with reference to exemplary arrangements it will be understood that it is not intended to limit the teaching to such arrangements as modifications can be made without departing from the spirit and scope of the present teaching.

It will be understood that while exemplary features of a system in accordance with the present teaching have been described that such an arrangement is not to be construed as limiting the invention to such features. The method of the present teaching may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method for retrieving information. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this disclsoure, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing through put and reducing processing requirements.

In general, the terms used in the following claims should not be construed to limit the disclosure to the specific examples disclosed in the specification, unless the above detailed description explicitly defines such terms. Accordingly, the actual scope of the disclosure encompasses not only the disclosed examples, but also all equivalent ways of practicing or implementing the disclosure under the claims.

From the foregoing, it will be appreciated that specific embodiments of the disclosure have been described herein for purposes of illustration, but that various modifications may be made without deviating from the spirit and scope of the disclosure. Accordingly the disclosure is not limited.

We claim:

1. A computer implemented method for retrieving information using a computer system; the method comprising:
inputting of data to generate one or more records;
storing the one or more records;
classifying one or more pieces of data in the one or more records so as to associate the pieces of data to one or more concepts;
enriching the one or more records with metadata identifying concepts to which the pieces of data are associated;
inputting a search query to motivate a search of the one or more records;
classifying data of the search query by associating the data of the search query to one or more concepts,
matching the one or more concepts associated with the data of the search query with the one or more concepts associated with the one or more records;
ranking and filtering matching records based on one or more factors;
and returning search hits based on the matching step which are ordered and filtered by
the ranking step.

2. The method of claim 1 wherein the one or more records comprise one or more fields.

3. The method of claim 1 wherein the one or more records comprises a plurality of fields of which at least one field includes text data.

4. The method of claim 1 wherein classification of the one or more pieces of data uses a repository of concept data and concept metadata.

5. The method of claim 4 wherein the repository includes nodes that represent concepts.

6. The method of claim 5 wherein the nodes have associated metadata.

7. The method of claim 6 wherein the metadata comprises identifiers, words and terms in the form of strings, types and scaled features.

8. The method of claim 4 wherein the repository comprises edges for connecting nodes thereby representing the interrelatedness of the concepts that the nodes represent.

9. The method of claim 8 wherein an edge has associated metadata that represent the type and strength of the relationship between the concepts represented by the two connected nodes.

10. The method of claim 1 wherein the classification of the one or more pieces of data includes using one or more comparison techniques.

11. The method of claim 10 wherein the one or more comparison techniques associate a given piece of text to zero, or one or more concepts with a confidence score.

12. The method of claim 10 wherein a set of configuration instructions determines the type, number and order of comparison techniques, as well as the selection of concept data from the repository.

13. The method of claim 12 wherein concept associations derived from different comparison techniques are combined to produce distinct set of associations along with scores indicating the confidence of those associations.

14. The method of claim 13 wherein the score generated for each association is dependent upon the comparison technique or combination of comparison techniques used to make that association.

15. The method of claim 13 wherein the score for an association depends on the relationship of that concept to other concept associations produced within that classification operation.

16. The method of claim 13 wherein the score for an association depends on the relationship of that concept to concept associations of data previously inputted data by a data provider.

17. The method of claim 13 wherein the score for an association depends on the relationship of that concept to concept associations of data previously inputted by social connections of a data provider.

18. The method of claim 13 wherein the score for an association depends on the relationship of that concept to concept associations of data previously inputted by other participants that share similar profile attributes to a data provider.

19. The method of claim 1 wherein the one or more records are stored along with identifiers of concepts to which they have been associated and scores indicating the confidence of those associations.

20. The method of claim 1 wherein records are stored along with associated geographical location data.

21. The method of claim 1 wherein matching the search queries includes classifying the search queries using a repository of concept data and concept metadata.

22. The method of claim 21 wherein a search engine is configured to match search queries to stored records based on concepts and geographical location data to which the search queries and stored records have been associated.

23. The method of claim 22 wherein during matching, dynamic adjustment of different thresholds are made to achieve a required volume of search hits.

24. The method of claim 23 wherein the dynamic adjustment includes adjusting geographical location data.

25. The method of claim 23 wherein the dynamic adjustment includes changing the concept type, or the combination of concept types, that constitute a valid match.

26. The method of claim 23 wherein the dynamic adjustment includes using certain similar or related concepts to the associated concepts of the search query to facilitate a match.

27. The method of claim 23 wherein the metadata of the concept associated to a search query determines thresholds for the dynamic adjustment.

28. The method of claim 1 wherein the one or more factors comprise at least one of:
a measure of textual similarity of the contents of the record and the search query;
a measure of conceptual similarity of the record and search query;
a measure of geographical proximity of a record provider to searcher who inputs the search query with reference to relativeness of that geographical proximity based on concept associated;
a measure of the likelihood that a search hit will be selected if present within the search hits;
a measure of the quality and volume of peer recognition of a search hit, or the provider of a search hit;
measures of quality, extensiveness and recency of content uploaded by the provider of the search hit;
a measure of volume and quality of content external to system referenced by the provider of the search hit;
a measure of quality and extensiveness of provider's social connections network;
a measure of interconnectivity of provider's social connections relative to the searcher's social connections; and
a measure of level of activity of the provider within the system.

29. A computer system for retrieving information; the system comprises:
a data input interface for inputting of data to generate one or more records;
a memory for storing the one or more records;
a classification module for classifying one or more pieces of data in the one or more records so as to associate the pieces of data to one or more concepts;
an enriching module for enriching the one or more records with metadata identifying concepts to which the pieces of data are associated;
a search interface configured to input a search query to motivate a search of the one or more records;
a classification search module configured for classifying data of the search query by associating the data of the search query to one or more concepts,
a matching module configured for matching the one or more concepts associated with the data of the search query with the one or more concepts associated with the one or more records;
a ranking module configured for ranking and filtering matching records based on one or more factors; and
a search engine configured for returning search hits based on the matching step.
